(19) United States
(12) Patent Application Publication
(10) Pub. No.: US 2026/0170039 A1
(43) Pub. Date: Jun. 18, 2026

(54) Trusted Introduction Orchestrator for Consent-Bound, Longitudinal Profiling and Matching

(71) Applicant: Aaron Urban, Monroe, WA (US)

(72) Inventor: Aaron Urban, Monroe, WA (US)

(21) Appl. No.: 19/366,318

(22) Filed: Oct. 22, 2025

Related U.S. Application Data
(60) Provisional application No. 63/710,827, filed on Oct. 23, 2024.
(60) Provisional application No. 63/717,280, filed on Nov. 7, 2024.

(51) Int. Cl. G06F 16/335; G06F 16/3329; G06F 21/62

(52) U.S. Cl. CPC G06F 16/337; G06F 16/33295; G06F 21/6245

(57) ABSTRACT

An orchestrated engine couples to a user-preferred conversational AI to build a longitudinal behavioral profile and a relationship/trust state R from multi-session interaction signals. A handshake controller uses R to govern prompt eligibility, tone, and depth. Before any external access, a utility/minimal-scope planner proposes least-privilege scopes based on expected utility; a privacy shell issues consent tokens and validates a currently valid, in-scope token at each retrieval with provenance logging. Thematic alignment emits dimension-importance that, with uncertainty and R, yields a composite priority score for next-prompt selection. An introduction gate withholds introductions until both a profile-completion threshold and R>=Rmin are satisfied; for pairings, cross-consent is validated at emission and disclosure is staged. The system applies across relationships, employment, and team formation.

### 2. CROSS-REFERENCE TO RELATED APPLICATIONS

This application claims the benefit under 35 U.S.C. § 119(e) of U.S. Provisional Patent Application Nos. 63/710,827 (filed Oct. 23, 2024) and 63/717,280 (filed Nov. 7, 2024). The entire contents of each of the foregoing applications are incorporated herein by reference.

### 3. TECHNICAL FIELD

The disclosure relates to computer-implemented systems for conversational, longitudinal behavioral and psychological profiling; trust-weighted prompting; least-privilege consent; provenance-enforced access to external data; and threshold-gated introductions to downstream applications (e.g., relationships, employment, team formation).

### 4. BACKGROUND

Conventional matching systems often rely on static questionnaires or opportunistic logs that can be gamed and lack minimality and provenance guarantees. Privacy mechanisms may record consent but do not combine consent economics (expected utility versus requested scope) with trust-weighted interrogation and threshold-gated release. There is a need for an orchestrated engine that builds a longitudinal user-AI relationship, earns trust, proposes least-privilege scope before any external retrieval, enforces per-retrieval validation with provenance, and withholds introductions until dual thresholds are satisfied.

### 5. SUMMARY

In one aspect, a system computes a relationship/trust state R for a user from multi-session interaction signals and uses R to modulate prompt eligibility, tone, and depth. Before any external retrieval, a Utility Estimator & Minimal-Scope Planner computes expected utility (ΔU) and proposes a least-privilege scope set. A Privacy Shell issues consent tokens (with scope, purpose, validity) and validates a currently valid, in-scope token at each retrieval, with fail-closed behavior on expiry or revocation and with provenance recorded. A Thematic Alignment module emits dimension-importance values used with uncertainty and trust to form a composite priority score for next-prompt selection. An Introduction Gate withholds any introduction until both a profile-completion threshold and a relationship-depth threshold are satisfied; for pairings, cross-consent is validated at emit time and staged disclosure is enforced. In some embodiments, biometric-derived features are processed on-device and only normalized feature vectors cross the Privacy Shell boundary.

### 6. BRIEF DESCRIPTION OF THE DRAWINGS

FIG. 1 is a block diagram of an example system architecture.

FIG. 2 is a flow diagram of an example orchestration pipeline with dual thresholds and per-retrieval token validation.

FIG. 2A is a flow diagram of an alternate embodiment that uses session-level validation and/or a trust-only gate (no external retrieval until R≥Rmin).

### 7. REFERENCE NUMERALS

80 User-Preferred Conversational Engine (UPAI)/client interface
120 Trust State Computer (R; optional dR/dt)
130 Handshake Controller
140 Utility Estimator & Minimal-Scope Planner (ΔU; least-privilege scope proposal pre-consent)
150 Thematic Alignment (dimension-importance)
160 Composite Prompt Selector (composite priority score for next prompt)
170 Profile Completion Tracker
180 Introduction Gate (dual thresholds; staged introduction)
190 Pairing/Cross-Consent Controller
200 Privacy Shell (protective boundary)
220 Consent Token Services—221 Issuer; 222 Validator; 223 Provenance Ledger
310 External Connectors—320 Social/Streaming/Browsing; 330 Resume/LinkedIn/Job sites; 340 Email/Calendar/Docs
400 Optional On-Device Biometric Feature Extractor
500 Data Stores (profile, consent logs, provenance, prompt history, results)
700 Inter-Module Message Bus/Interface (modules are operably coupled via 700)

### 8. DEFINITIONS AND NOTATION

8.1 Relationship/Trust State (R). A longitudinal record for a user comprising a bounded trust value R∈[0,1], an optional rate term dR/dt over a sliding window, and metadata (timestamps, recency weighting, provenance references). Updates may be hysteretic to reduce oscillation.
8.2 Interaction Signals. Conversational signals including one or more of: refusal→acceptance transitions; change in disclosure entropy; sentiment stability; cross-context consistency; engagement continuity. Optional biometric-derived features (e.g., speech prosody) may be included but are generated on-device and only normalized vectors are provided to the system.
8.3 Composite Priority Score (CPS). A function of uncertainty (e.g., variance or entropy over a dimension), trust R (optionally dR/dt), and dimension-importance emitted by Thematic Alignment. CPS drives next-prompt selection.
8.4 Consent Token. A signed data object including at least: subject identity reference; scope (sources, fields); purpose; validity window/expiry; consent_version; and provenance hash; recorded in or linked to the Provenance Ledger.
8.5 Least-Privilege Scope Set. The minimal set of scopes that meets a benefit threshold (e.g., ΔU≥β) for a stated purpose.
8.6 Profile-Completion Threshold (θ). A metric over profile dimensions (e.g., weighted confidence×coverage, optionally with recency) indicating sufficient completeness for reliable downstream use.
8.7 Introduction Package. A staged, scope-bounded disclosure for a single-party introduction (user→role/team) or pairwise introduction (user-user), emitted only under gate conditions.
8.8 Per-Retrieval Egress Channel. The single labeled egress path exposed by the Privacy Shell for external retrievals; requests are allowed only when Validator 222 confirms a currently valid, in-scope token and Provenance 223 logs the retrieval.

### 9. DETAILED DESCRIPTION

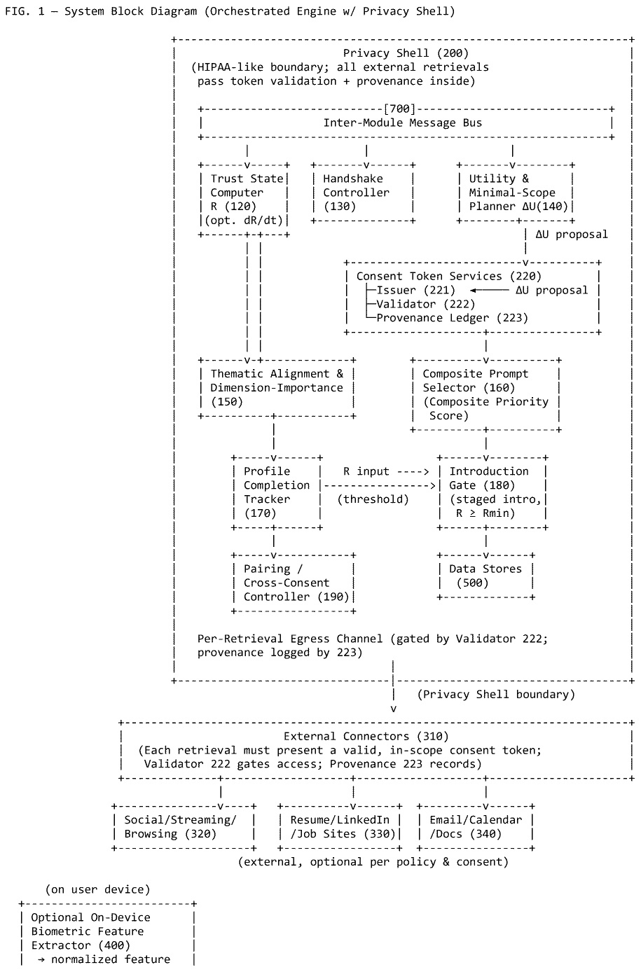

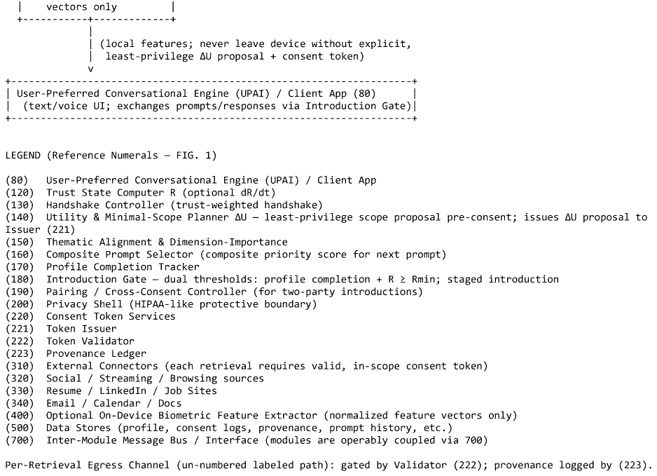

FIG. 1 illustrates an example architecture. A User-Preferred Conversational Engine 80 exchanges prompts and responses with components inside the Privacy Shell 200 over the Inter-Module Message Bus 700. The Trust State Computer 120 maintains R (and optionally dR/dt). The Handshake Controller 130 uses R to gate prompt eligibility, tone, and depth. The Utility Estimator & Minimal-Scope Planner 140 computes ΔU and proposes a least-privilege scope set before any external retrieval. Consent Token Services 220 comprise Issuer 221, Validator 222, and Provenance Ledger 223. The Thematic Alignment module 150 outputs dimension-importance values that, together with uncertainty and trust, feed the Composite Prompt Selector 160 to compute a CPS for the next prompt. The Profile Completion Tracker 170 monitors θ. The Introduction Gate 180 emits staged introductions only when θ is satisfied and R≥Rmin. The Pairing/Cross-Consent Controller 190 validates consent on both sides before any pairwise introduction. External Connectors 310 (including 320, 330, 340) are reachable only via the Per-Retrieval Egress Channel gated by 222 and logged by 223. Optional on-device biometric feature extraction 400 outputs normalized feature vectors that remain local unless explicit consent is issued by 221 under a least-privilege ΔU proposal. Data Stores 500 persist profile state, provenance, tokens, and results.

### 9.2 Trust Computation (120)

The system initializes R and optionally dR/dt for the user and updates both across sessions using interaction signals. R may be bounded and smoothed (e.g., exponential moving average). Negative events (e.g., revoked consent, inconsistent answers) may lower R with higher gain than positive events to deter oscillation. R and dR/dt are readable by 130, 160, and 180.

### 9.3 Trust-Weighted Handshake (130)

Before sensitive prompts, 130 checks eligibility thresholds derived from R and session context and may adjust tone, pacing, or question depth. If eligibility is not met, 130 directs a renewed inquiry path targeting missing or low-confidence dimensions instead of proceeding.

### 9.4 Least-Privilege Planning (140)

For any contemplated external retrieval, 140 computes ΔU for candidate scopes and proposes a least-privilege scope set sufficient to meet a stated purpose. The proposal is passed to Issuer 221. If the user consents, Issuer 221 mints a token binding identity, scope, purpose, a validity window, and a consent_version; if the user declines, no token is minted and the retrieval is not performed.

### 9.5 Consent Validation and Provenance (220, 221, 222, 223)

Validator 222 checks, per retrieval, that a presented token is valid, unexpired, unrevoked, and in-scope for the requested source and fields. Provenance 223 records at least the retrieval timestamp, requester identity, token reference, and a scope hash. The system fails closed on validation error, expiry, or revocation. Tokens can be individually revoked; revocation immediately blocks further retrievals.

### 9.6 Privacy Shell and Egress (200)

Privacy Shell 200 encloses internal modules and exposes a single Per-Retrieval Egress Channel for external access. No external retrieval occurs absent a recorded consent token validated by 222. The egress channel is auditable via 223.

### 9.7 Thematic Alignment and Composite Prompting (150, 160)

Thematic Alignment 150 computes dimension-importance over a controlled vocabulary of profile dimensions based on recent signals and goals. Composite Prompt Selector 160 computes a CPS using dimension-importance, uncertainty, and trust (and optionally dR/dt). 160 selects the next prompt and its presentation order. If CPS indicates insufficient confidence for a requested introduction, 160 prioritizes prompts that improve missing dimensions or increase R.

### 9.8 Dual-Threshold Gate and Staged Introduction (170, 180)

Introduction Gate 180 admits an introduction only when both thresholds are satisfied: profile completion θ from 170 and trust R from 120 meeting or exceeding Rmin. If either threshold is not met, 180 withholds the introduction and schedules renewed inquiry targeting prioritized dimensions until thresholds are satisfied. When the gate opens, 180 performs staged introduction: disclosing minimal attributes first; revealing additional attributes only as R and θ support them.

### 9.9 Pairing and Cross-Consent (190)

For two-party introductions, 190 validates that both parties' tokens are present and in-scope (or that the introduction relies solely on internally derived attributes under policy). 190 coordinates staged disclosures for both sides and records provenance entries for each disclosure step. If either party revokes consent, 190 terminates further disclosure.

### 9.10 Liveness and Fallback

The system operates without external data when no consent is present (trust-only mode). In this mode, 150 and 160 function on internal signals; 180 may still admit introductions if θ and R are satisfied using internal evidence. If an external source is unavailable or a token expires mid-flow, the system fails closed and falls back to renewed inquiry without dead-ending the session.

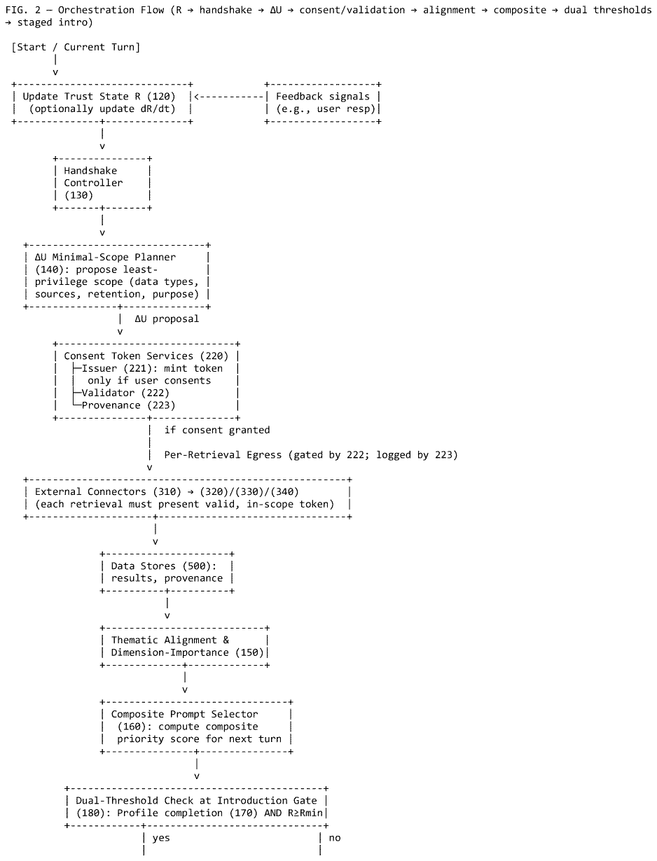

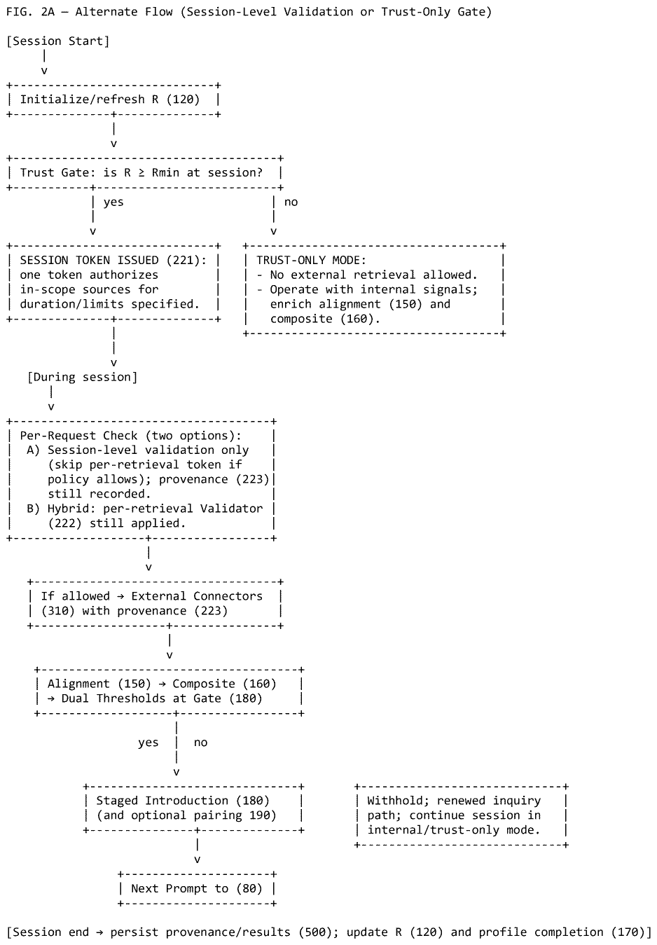

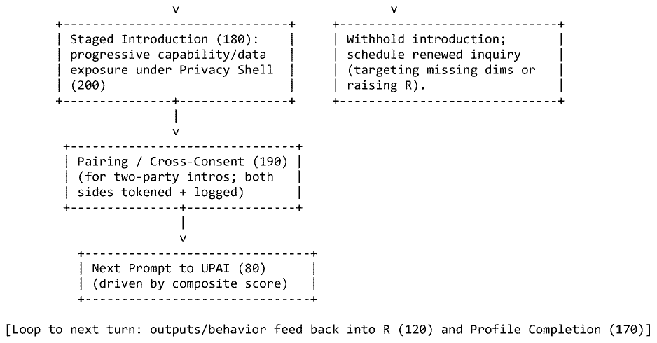

### 9.11 Alternative Embodiment: Session-Level Validation (FIG. 2A)

In some embodiments, Issuer 221 mints a session token that authorizes specified in-scope sources for the session duration and limits; provenance 223 still records each retrieval. In a hybrid approach, per-retrieval Validator 222 may still be applied even with a session token. In trust-only mode, if R<Rmin at session start, no external retrieval is permitted; the system proceeds with internal profiling until R≥Rmin.

### 9.12 Optional On-Device Biometrics (400)

Biometric-derived features (e.g., speech prosody, facial action units) may be computed on the user's device. Only normalized feature vectors leave the device and only when Issuer 221 has minted an explicit token for that purpose under a least-privilege ΔU proposal. Raw biometric data does not cross the Privacy Shell boundary.

### 9.13 Hardware and Implementation

The system may be implemented using one or more processors, memory, and persistent storage; components may be deployed across servers, edge devices, and user devices. Modules may be combined, separated, or distributed. Software may be implemented in any suitable programming language. Network communications may use standard transport and security protocols.

### 9.14 Inter-Module Coupling

“Operably coupled” includes direct or intermediary links. Inter-Module Message Bus 700 represents one or more data/control interfaces or message buses supporting the exchanges described.

### 9.15 Advantages

The orchestrated engine earns trust before access, proposes least-privilege scope, enforces per-retrieval validation with provenance, and withholds introductions until both profile completeness and trust thresholds are met—improving user control, transparency, auditability, and match quality over prior systems.

### 10. Embodiments in the Drawings (Text Support)

10.1 FIG. 1 (Architecture). Privacy Shell 200 encloses Trust State Computer 120, Handshake Controller 130, Utility Estimator & Minimal-Scope Planner 140, Thematic Alignment 150, Composite Prompt Selector 160, Profile Completion Tracker 170, Introduction Gate 180, Pairing/Cross-Consent Controller 190, Consent Token Services 220 (Issuer 221, Validator 222, Provenance 223), Data Stores 500, and Inter-Module Message Bus 700. The shell exposes a single Per-Retrieval Egress Channel to External Connectors 310 (including 320, 330, 340). UPAI 80 communicates with the internal modules to deliver prompts and receive staged introductions.
10.2 FIG. 2 (Orchestration Flow). The flow includes: update R (120); trust-weighted handshake (130); ΔU least-privilege proposal (140) to Issuer 221; token validation by 222 with provenance 223; external retrieval via the egress channel; alignment (150); composite selection (160); dual-threshold check at 180 using θ from 170 and R from 120; staged introduction; optional pairing/cross-consent (190); next prompt to UPAI 80; loop to update R and θ.

### FIG. 2

10.3 FIG. 2A (Alternate, Session-Level/Trust-Only). At session start the system either issues a session token if R≥Rmin or runs in trust-only mode (no external retrieval). During the session, validation may be session-level only or hybrid with per-retrieval checks. Alignment, composite, dual-threshold gating, and staged introductions proceed as in FIG. 2.

### FIG. 2a

### 11. Alternatives

Components may be combined (e.g., 130 and 160), renamed, or realized by services or processes. Storage schemas and token formats may vary. Thresholds, weighting functions, and CPS formulations may differ. The system may support additional connector classes under 310 and additional on-device feature types under 400.

### 12. Disclaimer

The foregoing description illustrates non-limiting embodiments. Scope is defined by the claims. Headings are for convenience and do not limit the invention.

1. A computer-implemented system comprising:
a conversational engine operably coupled to a language model to conduct multi-session interactions and ingest interaction signals for a user;
a trust state computer configured to compute and persist a longitudinal relationship/trust state (RTS) for the user including a trust value R bounded in [0,1], the RTS updated from multi-session interaction signals comprising one or more of refusal-to-acceptance transitions, disclosure entropy change, sentiment stability, cross-context consistency, and engagement continuity;
a handshake controller configured to modulate prompt eligibility, tone, and probing depth as a function of the RTS;
a thematic alignment module configured to map observed signals to behavioral or psychological dimensions and to emit dimension-importance values;
a prompt selector configured to compute a composite priority score based at least on uncertainty with respect to one or more dimensions, the trust value R, and the dimension-importance values, and to select a next prompt in response to the composite priority score;
a utility estimator and minimal-scope planner configured, prior to any external data retrieval, to evaluate whether external data would be beneficial and to propose a least-privilege scope set for such retrieval;
a privacy shell configured to enforce recorded user consent for external data retrieval and to maintain provenance of accessed data; and
an introduction gate configured to evaluate eligibility of an introduction to a downstream application using at least the RTS and a profile-completion score for the user and to withhold transmission of an introduction package unless an eligibility criterion is satisfied.

2. The system of claim 1, wherein the handshake controller changes prompt eligibility, tone, or probing depth monotonically with respect to increases or decreases in the trust value R.

3. The system of claim 1, wherein the thematic alignment module outputs per-dimension importance values that increase the composite priority score for dimensions with higher expected informational value.

4. The system of claim 1, wherein the privacy shell is further configured to block any external retrieval unless corresponding consent is currently recorded and in-scope for the proposed least-privilege scope set and to append provenance of each retrieval.

5. The system of claim 1, wherein the utility estimator and minimal-scope planner computes an expected utility for one or more candidate sources and proposes a least-privilege scope set prior to seeking consent for the external retrieval.

6. The system of claim 1, wherein the introduction gate withholds the introduction package when the profile-completion score is below a threshold and schedules renewed inquiry according to the composite priority score.

7. The system of claim 1, wherein for a candidate pairing the introduction gate is further configured to require that each party satisfies a profile-completion threshold before any attribute of either party is transmitted to the other.

8. The system of claim 1, wherein the trust state computer further computes a rate term dR/dt over a defined time window and the handshake controller or prompt selector uses the rate term in addition to the trust value R.

9. The system of claim 1, wherein prompt eligibility, tone, and probing depth are defined by policy functions of the RTS that enforce lower-sensitivity prompts when the RTS indicates low trust and higher-sensitivity prompts only when the RTS indicates sufficient trust growth.

10. The system of claim 1, wherein the privacy shell issues consent tokens bound to at least user identity, scope, and validity interval, and validates a currently-valid, in-scope consent token at each external data retrieval.

11. The system of claim 10, wherein revocation of a consent appends a revocation event and causes subsequent validations for the revoked scope to fail closed.

12. The system of claim 1, wherein the introduction gate performs staged disclosure comprising at least a teaser stage with anonymized attributes, a limited-attributes stage, and a contact-information stage.

13. The system of claim 7, wherein the system requires cross-referenced consents from both parties authorizing a limited introduction scope and validates each consent at a time of emission of the introduction package.

14. The system of claim 1, wherein upon detecting social-desirability bias or contradiction, the system reduces confidence for affected indicators, increases dimension-importance for orthogonal corroboration, schedules oblique cross-topic probes when eligibility next permits, and reevaluates the RTS.

15. The system of claim 1, wherein the interaction signals further comprise biometric-derived features computed from at least one of speech prosody or facial action units, and wherein biometric feature extraction is performed on-device and only normalized feature vectors are provided to the system.

16. The system of claim 1, wherein the RTS and profile are maintained per user identity across heterogeneous domains comprising one or more of relationships, employment, and team placement, and are transferred across domains only upon domain-specific consent.

17. The system of claim 6, wherein scheduling renewed inquiry comprises deferring one or more prompts until a next eligibility window determined by the composite priority score and the RTS.

18. The system of claim 1, wherein the introduction gate requires both a profile-completion threshold and a relationship-depth threshold satisfied by the trust value R before enabling the introduction.

19. A computer-implemented method comprising:
by a conversational engine operably coupled to a language model, conducting multi-session interactions and ingesting interaction signals for a user;
computing and persisting a longitudinal relationship/trust state (RTS) including a trust value R updated from the interaction signals;
controlling prompt eligibility, tone, and probing depth as a function of the RTS;
mapping observed signals to behavioral or psychological dimensions and emitting dimension-importance values;
computing a composite priority score based at least on uncertainty, the trust value R, and the dimension-importance values, and selecting a next prompt according to the composite priority score;
prior to any external data retrieval, evaluating whether external data would be beneficial and proposing a least-privilege scope set for such retrieval;
enforcing recorded user consent for external data retrieval and maintaining provenance of accessed data;
computing a profile-completion score for the user; and
withholding transmission of an introduction package to a downstream application unless an eligibility criterion based on at least the RTS and the profile-completion score is satisfied.

20. The method of claim 19, further comprising computing an expected utility for one or more candidate sources and proposing the least-privilege scope set prior to seeking consent for external retrieval.

21. The method of claim 19, further comprising issuing consent tokens bound to at least user identity, scope, and validity interval and validating a currently-valid, in-scope consent token at each external data retrieval.

22. The method of claim 19, wherein, for a candidate pairing, the method requires that both parties satisfy a profile-completion threshold and a relationship-depth threshold defined by the trust value R, and that cross-referenced consents authorizing an introduction scope are validated at a time of emission.

23. The method of claim 19, wherein transmitting the introduction package comprises staged disclosure including an anonymized teaser stage followed by a limited-attributes stage and, upon explicit approval, a contact-information stage.

24. The method of claim 19, further comprising, responsive to detecting social-desirability bias or contradiction, reducing confidence for affected indicators, increasing dimension-importance for orthogonal corroboration, scheduling oblique cross-topic probes when eligibility next permits, and reevaluating the RTS before retesting eligibility.

25. A non-transitory computer-readable medium storing instructions that, when executed by one or more processors, cause the processors to perform the method of claim 19.

26. The non-transitory computer-readable medium of claim 25, wherein the instructions further cause the processors to validate a currently-valid, in-scope consent token at each external data retrieval and to fail closed upon expiry or revocation.

27. The non-transitory computer-readable medium of claim 25, wherein the instructions further cause the processors to perform staged disclosure comprising teaser, limited-attributes, and contact-information stages for an introduction package.
